(19) United States
(12) Patent Application Publication
(10) Pub. No.: US 2003/0116453 A1
(43) Pub. Date: Jun. 26, 2003

(54) Carrier for promotional product

(75) Inventors: Kenneth J. Russo, Hinsdale, IL (US); Lawrence C. Noffke, Geneva, IL (US)

Correspondence Address: WELSH & KATZ, LTD., 22nd Floor, 120 South Riverside Plaza, Chicago, IL, 60606, US

(73) Assignee: Packaging Printing Specialists Incorporated.

(21) Appl. No.: 10/036,071

(22) Filed: Dec. 26, 2001

(51) Int. Cl. B65D 85/30; B32B 1/02; B65D 1/00

(52) U.S. Cl. 206/308.1; 428/35.2

(57) ABSTRACT

A multi-layer promotional product has a first film layer, patterned adhesive layer and a second layer fixedly attached to the first layer by the adhesive layer with a product carrying region defined therebetween. Prior to attaching the second layer, which could also carry the product, an intermediate layer with a release coating can be applied to the adhesive layer and removed prior to second layer being applied to the adhesive. A pull tab can be formed on the first or second layers to facilitate product removal.

### FIELD OF THE INVENTION

The invention pertains to product mailers. More particularly, the invention pertains to easily openable, substantially planar, multi-layer product mailers.

### BACKGROUND OF THE INVENTION

A variety of disk mailers are known. Known mailers have been formed of paper stock folded and glued to form a padded envelope with a disk receiving interior. Promotional mailers are also known.

Known promotional mailers require folding and gluing a blank, perhaps while incorporating a disk and providing an access feature such as a tearable tab or closure.

Some of the known mailers do not provide a view of the product they contain. One piece blanks can be pre-printed. However, they do not lend themselves to customer customizing and automated addressing as effectively as customer creatable roll or sheet stock intended to be integrated into a customer specific mailer.

It is also known in the prior art to form a multi-layer mailer with a base carrier sheet coated with a silicon release layer. A transparent film cover sheet is coated with an adhesive layer. A transparent film patch is deposited on the adhesive layer to form an adhesive-free region bounded by adhesive. The composite cover sheet, adhesive layer and patch are adhered to the release layer of the base carrier.

In subsequent processing, the composite is separated from the release layer and adhered to a product carrying base sheet without a release layer. The portion of the adhesive not covered by the patch adheres to the base sheet trapping the product between the patch, the base sheet and the bounding adhesive.

In the above mailer, the patch represents both an expense and a manufacturing complication. In addition, the product is always viewed between three layers, film-adhesive-film.

There continues to be a need for customizable mailers that display a product being delivered. Preferably such mailers would be cost effective to manufacture, easily openable by the ultimate recipient while at the same time effectively protecting the product during shipment.

### SUMMARY OF THE INVENTION

A multi-layer promotional product package provides product security, ease of access as well as customization opportunities for the product supplier. The package structure is suited to multi-stage processing.

A product precursor has a first planar film layer, a layer of patterned adhesive, and a second, release layer. The patterned adhesive is sandwiched between the layers. The adhesive is deposited so as to bound an interior, adhesive-free region. The layers and the patterned adhesive define a bounded, adhesive free, internal region.

Pluralities of product precursors can be formed as separate die cut sheets or as a continuous roll. Subsequent processing, which could be remote in both time and place, converts the pluralities of product precursors into deliverable product containing packages.

In the deliverable product containing package, the release layer is replaced with a product carrying paper or film backing layer which permanently attaches to the adhesive. The first film layer, the adhesive and the backing layer together, form a closed, product carrying container. The adhesive is excluded from an interior, product carrying adhesive-free region.

Representative products, without limitation include phone cards, booklets, scratch-off game cards, consumer product samples such as scratch and sniff cards, planar parts such as washers and the like as well as any other type of planar product which is to be delivered by a third party delivery service to an end user. The details of the product being delivered are not a limitation of the present invention.

In a preferred embodiment, a mailer for a compact disk such as a CD or a CD-ROM, has a flexible film layer with a tear or zipper-type tab for opening same. A second planar layer, which could be a resin film or a paper sheet member, is permanently attached to the first layer by a patterned pressure sensitive adhesive layer.

The patterned adhesive layer, located between the planar layers, defines, in part, an internal, adhesive free product receiving region. The adhesive free region can receive a disk.

The first film layer can be formed of a clear or translucent film. Representative film layers include polyester, polypropylene, polyvinylchloride. The second layer can include delivery information.

The adhesive can be pressure sensitive, heat sensitive or radiant energy sensitive. The planar layers can exhibit a square, rectangular or circular cross section.

An ultimate recipient of the package is able to view the product through a single film layer. The patterned adhesive layer forms a bounding periphery for the product containing region.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a top plan view of a multilayer pouch having a predetermined perimeter in accordance with the present invention;

FIG. 2 is a section taken along plane 2-2 of FIG. 1;

FIG. 3 is a top plan view of an alternate configuration of a pouch in accordance with the present invention;

FIGS. 4A-4D illustrate steps in a process of manufacturing delivery pouches in accordance with the present invention; and

FIGS. 5A-D illustrate respectively final processing and completed packaging in accordance with the invention.

### DETAILED DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

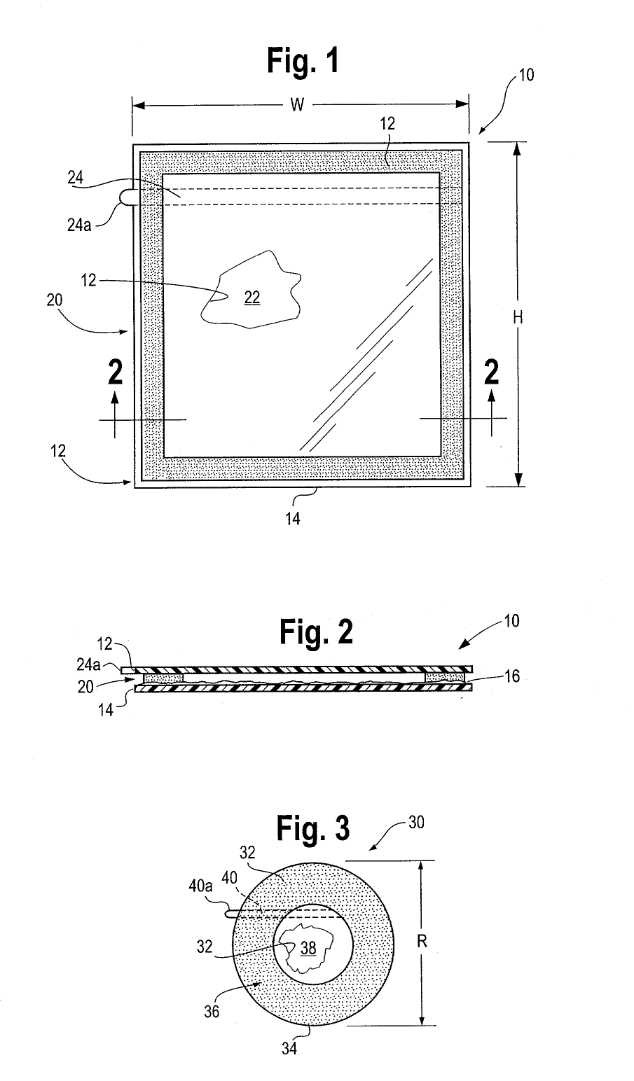

FIG. 1 illustrates a top plan view of an initial configuration of a multilayer pouch 10. The configuration 10 has a first or top layer 12 of a predetermined shape which could be formed of a clear or a translucent film. As illustrated, pouch 10 has an exemplary rectilinear shape with a height H and a width W.

The film can be polyester, polypropylene, polystyrene or polyvinylchloride. Thickness of the top ply 12 can vary in a range from 1 mil to 6 mils without limitation.

Pouch 10 includes a second or bottom ply 14 which can be formed of film, paper or the like without limitation. The thickness of appropriate film can be in a range of 0.5 mil to 2.0 mils. If paper, the bottom ply 14 can be in a range of 40 pound basis weight to 100 pound basis weight. The lower ply 14 is coated with a release layer 16, such as silicon.

A layer of patterned adhesive, indicated generally at 20, is sandwiched between the top ply 12 and the bottom ply 14. The adhesive can form a continuous periphery 20 illustrated in FIG. 1 or, if desired, can form a discontinuous periphery of a predetermined size and shape. The adhesive 20 bounds an adhesive free region indicated generally at 22 wherein a planar product, such as a compact disc, CD, can be placed for subsequent delivery.

Those of skill in the art will understand that the adhesive pattern 20 can take on a variety of shapes without limitation. Similarly, the exterior peripheries of the top ply 12 and bottom ply 14 also can be formed in a variety of shapes all without departing from the spirit and scope of the present invention. Advantageously, however, all of these respective perimeters of the top and bottom plys 12, 14 in combination with the patterned adhesive 20 will produce an interior, substantially closed region for receipt of a selected product.

The adhesive 20 can be pressure-sensitive adhesive, temperature responsive adhesive or radiant energy responsive adhesive of a type known to those of skill in the art which can be deposited in a predetermined form on either the top ply 12 or bottom ply 14 as the multilayer assemblage 10 is being manufactured. The exact nature of the adhesive is not a limitation of the present invention.

The release layer 16 is provided so that the selected adhesive will not permanently bond to the bottom ply 14. As discussed subsequently, bottom ply 14 will be removed and replaced in the process of manufacturing a completed product delivery container 10′.

FIG. 1 also illustrates a preformed zipper-type perforated strip 24 by which a recipient of a delivered container or mailer 10′ can conveniently open same without having to separate the layers 12, 14. The recipient merely pulls on a free end 24a of strip 24 tearing same from first ply 12 and opening the internal region 22. The delivered product can then be extracted from the adhesive free region.

FIG. 3 illustrates a top plan view of an alternate multilayer pouch 30. Pouch 30 has a top ply, film layer 32, a bottom ply 34 which carries a release layer, comparable to the release layer 16 and a layer of patterned adhesive indicated generally at 36. The pouch 30 as illustrated in FIG. 3 is cylindrical with the patterned adhesive layer 36 forming an annular ring around an adhesive-free central region 38.

The multilayer pouch 30 also carries a perforated opening strip 40 with a pull tab 40a comparable to the perforated strip 24 and pull tab 24a.

While the pouch 10 has been illustrated as generally rectangular or polygonal and the assemblage 30 has been illustrated as cylindrical, it will be understood that other external peripheries, oval, elliptical, triangular and the like come within the spirit and scope of the present invention.

The pouches 10 or 30 are particularly advantageous in that they can be manufactured in roll or sheet form and then forwarded to a third party finisher who in turn combines the respective pouches 10 or 30 with a permanently attached label and a product contained in the adhesive-free region such as 22 or 38.

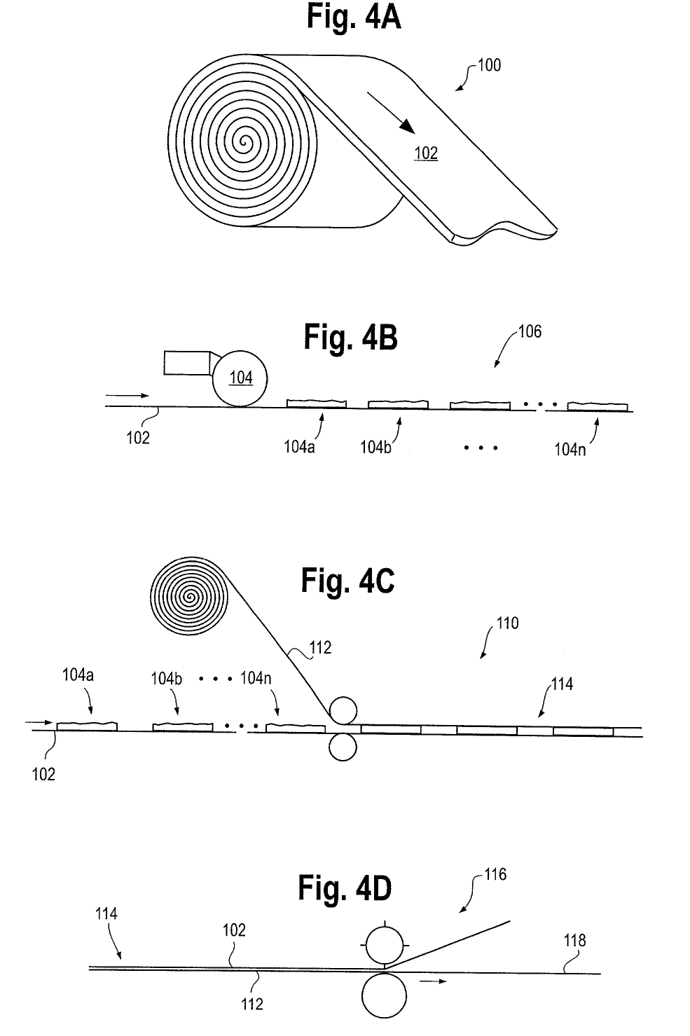

FIGS. 4A-D illustrate a process of manufacturing multilayer pouches such as 10 or 30. As illustrated in FIG. 4A, in an initial step 100, sheet film 102, usable for the first or upper ply 12 or 32 is extracted from a roll and fed into an adhesive pattern coater 104 in a step 106 illustrated in FIG. 4B.

The pattern coater 104 is effective to apply a plurality of spaced apart adhesive patterns indicated generally at 104a, 104b, 104n on the film 102. Each of the adhesive patterns, such as pattern 104b, corresponds to a predetermined adhesive pattern such as adhesive pattern 20, FIG. 1 or 36, FIG. 3. While coater 104 has been illustrated applying pressure-sensitive adhesive to the film 102, it will be understood that other types of adhesive, thermally activated as well as radiant energy activated, could be applied without departing from the spirit and scope of the present invention.

In a step 110, illustrated in FIG. 4C, release liner 112, corresponding to liner 14, FIG. 1 or 34, FIG. 3, in sheet form is drawn off a roll and laminated or nipped to the adhesive coated film 102 thereby forming a multilayer web 114 having a plurality of spaced apart adhesive-free regions, such as region 22 or 38. The members of the plurality, in a step 116, illustrated in FIG. 4D, can be die cut forming a finished multilayer product 118, corresponding to the product 10 or 30 either in roll or sheet form.

The product 118 can then be fed, in either roll or sheet form to a product carrier, for example a carrier with a plurality of compact disks, and can be hand-affixed thereto. Alternately, members of the plurality can be or automatically affixed by removing release liner, such as the liner 14 or 34 and combining the top ply 12 or 32 along with the patterned adhesive layer 20 or 36 with a carrier in either roll or sheet form. The carriers can be preprinted with a plurality of advertisements, delivery instructions such as mailing addresses or the like. In the process, the respective product such as a CD, can be inserted into the respective adhesive free regions such as 22 or 38 for subsequent access by the recipient of the package.

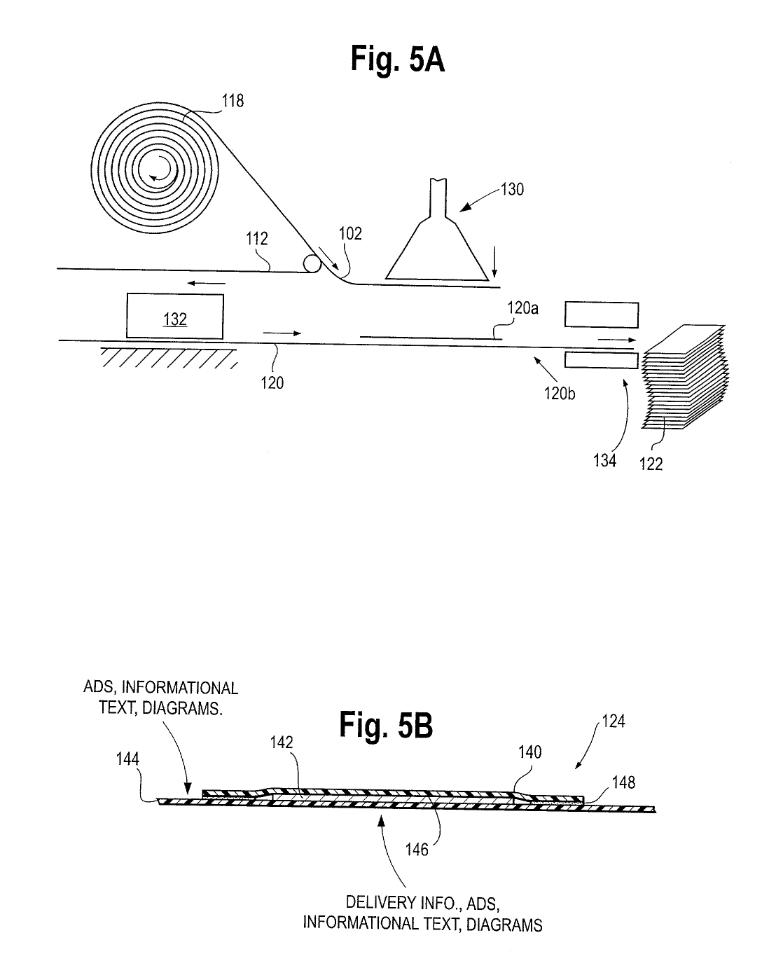

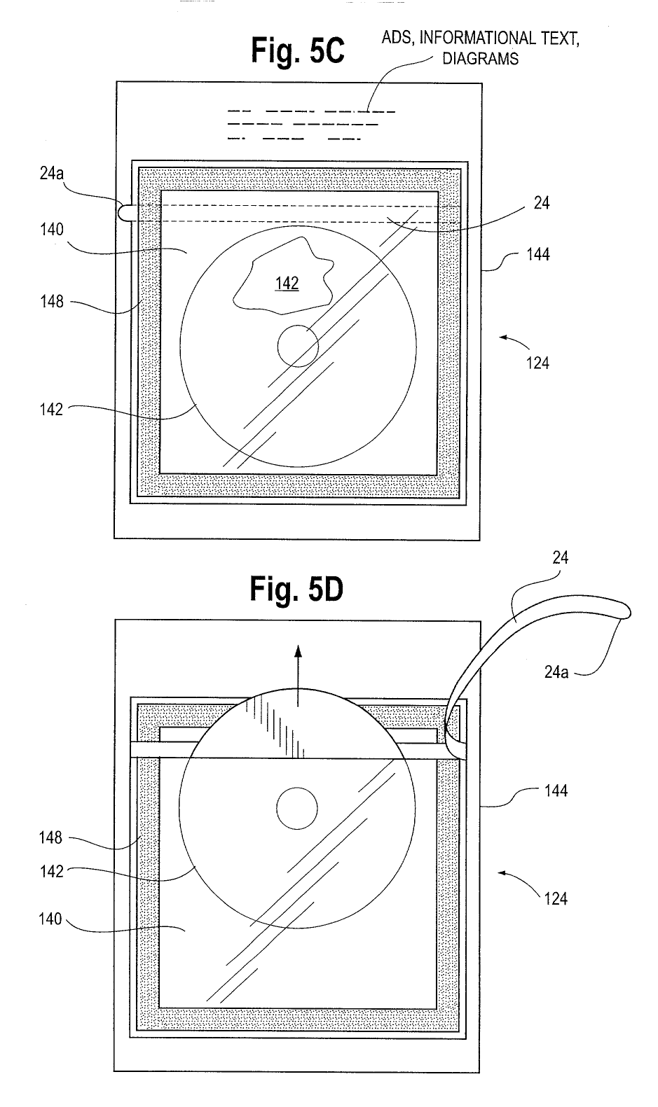

FIG. 5A illustrates processing steps for converting the package precursors 118, illustrated in roll form, into final product carrying packages. The roll of product precursors, 118, is split into a web of pouches 102 carrying patterned adhesive and a pealed off release liner 112. The pouch/adhesive web 102 is fed into pouch dispensing apparatus 130. The apparatus 130 laminates the web of pouches 102 onto a properly registered backing web 120 which is carrying a plurality of spaced apart products, such as product 120a. The products, such as product 120a, are enclosed in respective closed packages in mailer web 120b. Web 120 can also carry advertising, or other informational text or diagrams. Web 120 can be a bonded or a cover weight paper.

Web 118 can be preprocessed by printer or label applier 132. Delivery information can be printed onto the web 118. Alternately, preprinted labels can be applied to the web 118 in unit 132.

The web 120b can be fed through die cutting unit 134 to form a stack or plurality of separate, deliverable carriers 122. FIGS. 5B-D illustrate aspects of representative completed mailers such as the mailer 124c.

In mailer 124, a transparent film cover 140 enables an ultimate recipient of the delivered carrier to directly view the enclosed product, such as product 142 which could a compact disk, phone card or any other type of planar product to be delivered. A backing sheet 144 closes the product carrying region 146 which is bounded by a peripheral adhesive layer 148.

A tear open tab, such as tab 24a and strip 24, can be used to open cover 140 to enable a recipient to remove the product 142. An alternate form of a tab can be formed on a corner of the cover 140. A recipient can pull the cover 140 from the backing sheet 144 using the tab. Other opening mechanisms can be used without departing from the spirit and scope of the present invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A carrier for a substantially planar object comprising:
a first planar layer of a selected shape wherein the planar layer layer carries a carrier opening feature;
a patterned, condition sensitive adhesive bonded to the first layer wherein the pattern substantially bounds an adhesive free region wherein the adhesive-free region defines a size and shape for receiving the planar object;
a second planar layer substantially permanently attached to the patterned adhesive bounding and closing the adhesive-free region and defining an object receiving region between the layers and the adhesive-free region whereby the object is accessible via the carrier opening feature.

2. A carrier as in claim 1 wherein the carrier opening feature comprises a first planar layer separating member which provides access to the object receiving region without separating the first planar layer from the second planar layer.

3. A carrier as in claim 2 wherein the planar layer separating member comprises an elongated body portion, integrally formed in the first planar layer, and separable therefrom in the presence of an opening force.

4. A carrier as in claim 3 wherein the body portion is releasibly joined to the first layer by an elongated plurality of weakened, separable regions.

5. A carrier as in claim 1 wherein the adhesive is one of pressure responsive, thermally responsive and radiant energy responsive.

6. A carrier as in claim 2 wherein the adhesive is one of pressure responsive, thermally responsive and radiant energy responsive.

7. A carrier as in claim 6 wherein the adhesive pattern defines a size and shape for receipt of a compact disk and wherein the second layer is adapted to receive and to substantially permanently carry delivery information.

8. A carrier as in claim 6 wherein the adhesive layer, in combination with the first and second layers contains a promotional product and wherein the product is removable therefrom in response to tearing the first layer via the separating member.

9. A carrier as in claim 2 wherein at least the first planar layer comprises a cured, flexible resin.

10. A delivery pouch for a planar product comprising:
a flexible film member which carries an elongated opening tab, and, a patterned, interrupted, adhesive layer which defines, in part, an internal, product receiving region wherein the region is substantially free from adhesive, and, wherein the adhesive defines, at least in part, a product shipping container;
a first, planar, region closing member removably affixed to the adhesive layer wherein the receiving region is further bounded by the film member and the first closing member; and
a second, planar, region closing member fixedly attached to the adhesive layer, in the absence of the first member, wherein the receiving region is fixedly bounded by the film member, the second planar member and the adhesive layer.

11. A pouch as in claim 10 wherein the opening tab has a zipper-like structure.

12. A pouch as in clam 10 wherein the adhesive layer defines one of a circular region and a region bounded at least in part by elongated, substantially linear adhesive members.

13. A pouch as in claim 12 wherein the adhesive is selected from a class which includes pressure sensitive adhesive, heat sensitive adhesive and radiant energy sensitive adhesive.

14. A pouch as in claim 10 wherein the first region closing member includes a release layer adjacent to the adhesive layer.

15. A process for preparing a package for an object comprising:
providing a first, planar sheet member;
providing a release liner;
depositing a plurality of substantially identical, spaced apart, adhesive patterns, such that each pattern bounds an adhesive free region, on one of the first sheet member and the release liner;
positioning the adhesive patterns between the first planar member and the release layer; and
readying the packages for further processing by forming one of a roll and a plurality of sheets.

16. A process as in claim 15 which includes removing the release layer and combining the first planar sheet member and adhesive with a product and a backing layer which is permanently affixed to the adhesive wherein the combining step locates the product in an adhesive free, enclosed region.

17. A process as in claim 15 which includes incorporating a plurality of spaced apart opening members in the first planar sheet member.

18. A process as in claim 17 which includes locating the opening members with a selected relationship relative to the adhesive patterns.

19. A process as in claim 16 which includes incorporating a plurality of spaced apart opening members in the first planar sheet member.

20. A process as in claim 19 which includes locating the opening members with a selected relationship relative to the adhesive patterns.

21. A process as in clam 15 which includes, in the depositing step, depositing in a discontinuous configuration at least one of pressure sensitive adhesive, thermally activated adhesive, and radiant energy activated adhesive.

22. A process as in claim 21 wherein the adhesive is deposited so as to form a substantially closed pattern.

23. A process as in claim 22 which includes forming one of a curved, substantially closed pattern and a polygonal substantially closed pattern.

24. A process as in claim 16 which includes applying delivery indicia to one of the layers.

25. A multi-layer easily operable product mailer comprising:
a first ply formed of a flexible film;
a second ply formed of a flexible sheet material coated with an adhesive release layer;
a substantially closed adhesive pattern formed on the first ply and defining an interior adhesive free product region;
wherein in a first state, the second ply is releasibly attached to the adhesive pattern; and
a third ply non-releasibly attachable to the adhesive pattern in the absence of the second ply to form a fixedly closed product containing region openable with a separating tab.

26. A product mailer as in claim 25 wherein the tab includes an opening member for perforating one of the first ply and third ply.

27. A product mailer as in claim 26 wherein the separating tab is formed in the first ply.

28. A product mailer as in claim 26 wherein the separating tab is integrally formed with a weakened, separable, elongated portion of the respective ply.
